(19) United States
(12) Patent Application Publication
(10) Pub. No.: US 2011/0260928 A1
(43) Pub. Date: Oct. 27, 2011

(54) PATCH ANTENNA AND METHOD OF MAKING PATCH ANTENNA

(76) Inventors: Tsutomu Ito, Tokyo (JP); Kouzo Shimizu, Tokyo (JP); Junichi Noro, Tokyo (JP)

(21) Appl. No.: 13/090,374

(22) Filed: Apr. 20, 2011

(30) Foreign Application Priority Data
Apr. 27, 2010 (JP) 2010-101709

(51) Int. Cl. H01Q 1/38; H01P 11/00

(52) U.S. Cl. 343/700 MS; 29/601

(57) ABSTRACT

A patch antenna can prevent a feed point (solder) from rising upward beyond the main surface of an antenna radiation electrode, and a method of making that patch antenna. A dielectric base plate (12A) has, on its top surface (12u) side, a recess (12c) that is provided in the periphery of a base plate through-hole (12a). This recess (12c) is able to accommodate a head (181) of a feed pin (18) and solder (15A), and also has a depth that is greater than the height of the head (181) of the feed pin (18). The antenna radiation electrode (14A) is formed on inner wall surfaces (12c-1) defining the recess (12c). In a state in which the head (181) of the feed pin (18) is accommodated in the recess (12c), solder (15A) is placed not to project upward beyond the main surface of the antenna radiation electrode (14A).

### CROSS REFERENCE TO RELATED APPLICATIONS

This application is entitled to and claims the benefit of Japanese Patent Application No. 2010-101709, filed on Apr. 27, 2010, the disclosure of which, including the specification, drawings and abstract, is incorporated herein by reference in its entirety.

### TECHNICAL FIELD

The present invention relates to a patch antenna and a method of making the patch antenna. More particularly, the present invention relates to a patch antenna that is suitable for an antenna to be mounted on a vehicle, such as an automobile.

As commonly known in this field of technology, various antennas are mounted on a vehicle such as an automobile. These antennas include, for example, a GPS (Global Positioning System) antenna, an SDARS (Satellite Digital Audio Radio Service) antenna, and so on.

GPS is a satellite positioning system using artificial satellites. In GPS, out of twenty four satellites (hereinafter referred to as “GPS satellites”) orbiting around the earth, electric waves (GPS signals) from four of these GPS satellites are received, and, by measuring the positional relationships and time gaps between these GPS satellites and a mobile body from the electric waves received, the position and height of the mobile body on a map is calculated accurately, based on the principle of triangulation.

In recent years, GPS is used for a car navigation system for detecting the position of a traveling automobile, and has become very popular. A car navigation apparatus is comprised of a GPS antenna for receiving a GPS signal, a processing apparatus for processing a GPS signal received by the GPS antenna and detecting the current location of a vehicle, and a display apparatus for displaying the location detected by the processing apparatus on a map. An example of a GPS antenna includes a planar antenna like patch antenna.

SDARS is a digital broadcast service using satellites (hereinafter referred to as “SDARS satellites”) in the United States of America. That is to say, in the United States, a digital radio receiver for receiving satellite waves from SDARS satellites or terrestrial waves and listening to digital radio broadcast has been developed and in practical use. Today, in the United States, two broadcast stations called “XM” and “Sirius” are providing radio programs of over 250 channels nationwide. This digital radio receiver is generally mounted on a mobile body such as an automobile and receives electric waves of frequencies in approximately the 2.3 GHz band to listen to radio broadcast. That is to say, a digital radio receiver is a radio receiver to make it possible to listen to mobile broadcast. Since the frequencies of electric waves to be received are approximately in the 2.3 GHz band, the wavelength λ to be received then (that is, resonant wavelength) is approximately 128.3 mm. By the way, a terrestrial wave is acquired by slightly shifting the frequency of a satellite wave received once at an earth station and retransmitting the frequency-shifted electric wave with linear polarization. Like the above GPS antenna, an example of an SDARS antenna includes a planar antenna like patch antenna.

An XM satellite radio antenna apparatus receives circular polarized electric waves from two stationary satellites, and receives electric waves by terrestrial linear polarization equipment in a blind zone. On the other hand, a Sirius satellite radio antenna apparatus receives circular polarized electric waves from three (synchronous) orbiting satellites, and receives electric wave by terrestrial linear polarization equipment in a blind zone.

A digital radio receiver may be mounted on an automobile, may be a fixed type to be placed indoors, or may be a portable type that has a battery as a power supply and can be carried around.

Now, conventional patch antenna 10 will be described with reference to FIG. 1 to FIG. 3. FIG. 1 is a perspective view of patch antenna 10. FIG. 2A is a plan view of patch antenna 10, FIG. 2B is a front view of patch antenna 10, FIG. 2C is a left side view of patch antenna 10, and FIG. 2D is a bottom view of patch antenna 10. FIG. 3 is a cross sectional view along line III-III in FIG. 2A.

As shown in FIG. 1, an orthogonal coordinate system (x, y, z) is used. In the state shown in FIG. 1, the x-axis direction encompasses the right and left directions (width directions or lateral directions), the y-axis direction encompasses the front and rear directions (depth directions or vertical directions), and the z-axis direction encompasses the upward and downward directions (height directions or thickness directions).

Patch antenna 10 is comprised of dielectric base plate 12 having an approximately cuboid shape, antenna radiation electrode (radiation element) 14, ground electrode (ground conductor) 16, and rivet-shaped feed pin 18. Antenna radiation electrode 14 is also referred to as “receiving electrode” or “patch electrode.”

A ceramic material of high permittivity, such as barium titanate, is used for dielectric base plate 12. Dielectric base plate 12 has top surface (surfaces) 12u, bottom surface (back surface) 12d, and side surfaces 12s. In the example illustrated, side surfaces 12s of dielectric base plate 12 are chamfered. In dielectric base plate 12, in the position feed point 15 (described later) is provided, base plate through-hole 12a that penetrates from top surface 12u to bottom surface 12d, is drilled.

Antenna radiation electrode (radiation element) 14 is formed of a conductor, and is formed on top surface 12u of dielectric base plate 12. Antenna radiation electrode (radiation element) 14 has a virtually square shape. Also, antenna radiation electrode (radiation element) 14 is formed by, for example, silver pattern printing.

Ground electrode (ground conductor) 16 is formed of a conductor, and is formed on bottom surface 12d of dielectric base plate 12. This ground electrode (ground conductor) 16 has ground opening 16a that is virtually concentric with base plate through-hole 12a, and that has a greater diameter than the diameter of base plate through-hole 12a.

Feed point 15 is provided in a position displaced in the x-axis direction and y-axis direction from the center of antenna radiation electrode 12. Upper end 18a of feed 18 is connected to this feed point 15. Feed pin 18 extends through base plate through-hole 12a and ground opening 16a, and then, apart from ground electrode (ground conductor) 16, extends further downward.

Here, solder is used for feed point 15. It then follows that this feed point 15 has a projecting shape that rises upward from the main surface of antenna radiation electrode 14.

Feed pin 18 that is illustrated is formed with a rivet pin having head 181 provided in upper end 18a, and bar-shaped body 182 that extends from upper end 18a to lower end 18b. In this case, in a state in which head 181 of rivet pin (feed pin) 18 projects from the main surface of antenna radiation electrode 14, the head 181 of rivet pin (feed pin) 18 is jointed with antenna radiation electrode 14 by means of solder 15. It then follows that this jointing part becomes a projecting shape to function as feed point 15.

As for the method of soldering (that is, mounting) feed pin 18, there is, for example, a method of soldering feed pin 18 using a soldering iron by human hands. However, with this method, there is a problem that the amount of solder is not fixed. The height of solder is not fixed either. When a casing (cover) touches the soldering part of feed pin 18, the value of capacity (i.e. capacitance) that applies to the surroundings of feed pin 18 changes. As a result of this, influence upon the tuning frequency of patch antenna 10 emerges as a problem. To prevent feed pin 18 and casing (cover) from touching, substantial clearance needs to be provided for feed pin 18 case (cover).

Various prior art references related to the present invention are known. For example, patent literature 1 discloses a patch antenna that has good antenna characteristics and allows reliable soldering of a feed pin. This patent literature 1 discloses, as one embodiment, a patch antenna in which a recess (i.e. cavity) that constitutes part of an opening of a through-hole (i.e. base plate through-hole) and that can accommodate the head of a feed pin, is formed on the upper surface (top surface) of a dielectric block (dielectric base plate). By this means, the head of the feed pin does not project from the upper surface (top surface) of the dielectric block (dielectric base plate). The diameter of the recess is set substantially equal to the diameter of the head of the feed pin, and the depth of the recess is set greater than the height of the head of the feed pin. Furthermore, the inner bottom surface and side surfaces of the recess are covered by a radiation electrode (antenna radiation electrode), like the upper surface (top surface) of the dielectric block (dielectric base plate). In this case, the feed point (solder) has a projecting shape that rises upward from the main surface of the radiation electrode (antenna radiation electrode).

Patent literature 2 also discloses, as one embodiment, a patch antenna having the same structure as the patch antenna disclosed in patent literature 1 above.

Furthermore, patent literature 3 discloses a method of soldering a feed pin of a patch antenna, whereby the amount of solder can be reduced without deteriorating the strength of connection. This feed pin soldering method disclosed in patent literature 3 includes the steps of applying N solder pastes (N being an integer of 2 or greater) that are provided mutually spaced apart and that are provided in a circular symmetry with respect to the center line of a base plate through-hole, on an antenna radiation electrode, pushing in a feed pin in the base plate through-hole from the top surface of a dielectric base plate and placing the head of the feed pin on the N solder pastes, and melting the N solder pastes by reflow and soldering the feed pin.

### PTL 1: Japanese Patent Application Laid-Open No. 2006-238430

### PTL 2: Japanese Patent Application Laid-Open No. 2008-66979

### PTL 3: Japanese Patent Application Laid-Open No. 2009-260673

However, with the patch antennas disclosed in patent literature 1 and patent literature 2, like conventional patch antennas 10 shown in FIG. 1 to FIG. 3, feed point 15 (solder) has a projecting shape that rises upward from the main surface of antenna radiation electrode 14. As a result of this, it is difficult to make the patch antenna small and thin (that is, have low profile). In particular, a patch antenna to be incorporated in the small and simple navigation system called “PND (Personal Navigation Device)” or a mobile telephone needs to have a smaller and lower-profile shape than conventional shapes and requires higher reliability. Consequently, a conventional patch antenna claims a certain height in the rising part of feed point (solder) 15 and therefore cannot be made thin (low profile).

Patent literature 3 simply discloses applying N solder pastes that are provided mutually spaced apart and that are provided in a circular symmetry with respect to the center line of a base plate through-hole, on an antenna radiation electrode, and then placing the head of a feed pin on N solder pastes, melting the N solder pastes by reflow, and soldering the feed pin.

Consequently, even if the feed pin soldering method disclosed in patent literature 3 is applied to the patch antenna disclosed in patent literature 1 or patent literature 2, feed point (solder) 15 still rises upward from the main surface of antenna radiation electrode 14. This is because the diameter of the recess (cavity) is set approximately equal to the diameter of the head of a feed pin, and, as shown in FIGS. 4A TO 4C of patent literature 1 and FIG. 7 of patent literature 2, the solder (feed point) still forms a projection that rises upward from the main surface of the antenna radiation electrode.

It is therefore an object of the present invention to provide a patch antenna of a thin shape (low profile) that can prevent a feed point (solder) from rising upward beyond the main surface of an antenna radiation electrode, and a method of making the patch antenna.

Another object of the present invention is to provide a patch antenna that can improve antenna gain (antenna characteristic) and a method of making the patch antenna.

Yet another object of the present invention is to provide a patch antenna that can be accommodated in a thin case and that improves antenna characteristics, and a method of making the patch antenna.

### SUMMARY OF INVENTION

To achieve the above-stated object, a patch antenna (10A) according to the present invention has: a dielectric base plate (12A) which has a top surface (12u) and a bottom surface (12d) that oppose each other and in which a base plate through-hole (12a) to penetrate from the top surface to the bottom surface is drilled in a predetermined location; an antenna radiation electrode (14A) which is formed on the top surface (12u) of the dielectric base plate; a ground electrode (16) which is formed on a bottom surface (12d) of the dielectric base plate and which has a ground opening (16a) that is substantially concentric with the base plate through-hole and has a greater diameter than a diameter of the base plate through-hole; and a feed pin (18) which has a head (181) that is provided in an upper end (18a) and a bar-shaped body (182) that extends from the upper end to a lower end (18b), the head being connected to the antenna radiation electrode by means of solder in the predetermined location, and the lower end being derived toward the bottom surface of the dielectric base plate via the base plate through-hole and the ground opening, and, in this patch antenna, the dielectric base plate (12A) has a recess (12c) that is provided in a periphery of the base plate through-hole on a side of the top surface, the recess being able to accommodate the head (181) of the feed pin and the solder (15A;15B) and having a depth greater than a height of the head of the feed pin; the antenna radiation electrode (14A) is formed on inner wall surfaces (14c-1) defining the recess (12c); and in a state in which the head of the feed pin is accommodated in the recess, the solder (15A;15B) is placed not to project upward beyond a main surface of the antenna radiation electrode (14A).

A method of making a patch antenna according to the present invention solders a feed pin (18) having a head (181) that is provided in an upper end and a bar-shaped body (182) that extends from the upper end to a lower end, to a dielectric base plate (12A), and this includes the steps of: preparing a dielectric base plate (12A) which has a top surface (12u) and a bottom surface (12d) that oppose each other, in which a base plate through-hole (12a) to penetrate from the top surface to the bottom surface is drilled in a predetermined location, and in which a recess (12c) that is able to accommodate a head (181) of a feed pin and that has a depth greater than a height of the head of the feed pin is provided in a periphery of the base plate through-hole (12a) on a side of the top surface; forming a ground electrode (16) on the bottom surface (12d) of the dielectric base plate (12A), the ground electrode having a ground opening (16a) that is substantially concentric with the base plate through-hole (12a) and that has a greater diameter than a diameter of the base plate through-hole; and forming an antenna radiation electrode (14A) on the top surface (12u) of the dielectric base plate and on inner wall surfaces (12c-1) defining the recess; placing a solder paste (15A;15B) on the antenna radiation electrode (142) formed on the inner wall surfaces of the recess in a location where the head of the feed pin is placed; pushing the body (182) of the feed pin (18) in the base plate through-hole (12a) from the top surface (12u) of the dielectric base plate (12A), deriving the lower end toward the bottom surface (12d) of the dielectric base plate (12A), and placing the head (181) of the feed pin on the solder paste (15A;15B); and melting the solder paste by reflow and soldering the feed pin.

The above reference numerals and codes in parentheses are assigned for ease of understanding, by way of example, and are by no means limiting.

According to the present invention, a recess is provided on the periphery of a base plate through-hole on the top surface side of a dielectric base plate and this recess can accommodate the head of a feed pin and solder and also has a depth that is greater than the height of the head of the feed pin, so that it is possible to prevent a feed point (solder) from rising upward beyond the main surface of an antenna radiation electrode.

### BRIEF DESCRIPTION OF DRAWINGS

FIG. 1 is a perspective view of a conventional patch antenna;

FIGS. 2A to 2D show the conventional patch antenna shown in FIG. 1, where FIG. 2A is a plan view of the conventional patch antenna, FIG. 2B is a front view of the conventional patch antenna, FIG. 2C is left side view of the conventional patch antenna, and FIG. 2D is a bottom view of the conventional patch antenna;

FIG. 3 is a cross sectional view along line III-III in FIG. 2A;

FIGS. 4A to 4C show a patch antenna pattern according to the first embodiment of the present invention, where FIG. 4A is a plan view of a patch antenna, FIG. 4B is a right side view of the patch antenna, and FIG. 4C is a bottom view of the patch antenna;

FIG. 5 is a cross sectional view alone line V-V in FIG. 4A;

FIG. 6A to FIG. 6G are cross sectional views showing the steps of making the patch antennas shown in FIGS. 4A to 4C and FIG. 5; and

FIG. 7 is a plan view showing part of the steps of making a patch antenna according to a second embodiment of the present invention, where a head of a feed pin is soldered to an antenna radiation electrode in four places at circular symmetrical locations (spaced at equal angular intervals).

### DETAILED DESCRIPTION OF PREFERRED EMBODIMENTS

Now, embodiments of the present invention will be described with reference to the accompanying drawings.

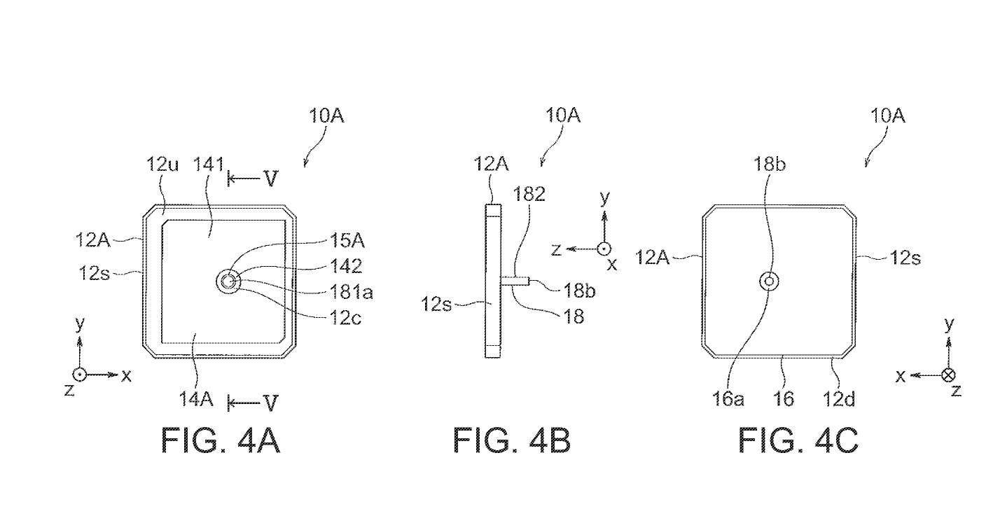

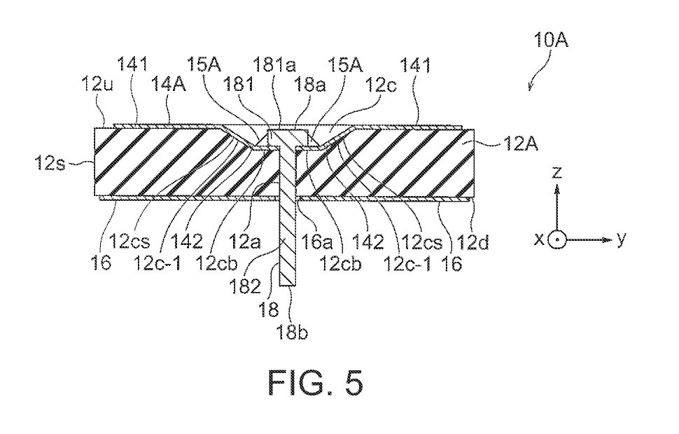

First, patch antenna 10A according to the first embodiment of the present invention will be described with reference to FIGS. 4A to 4C and FIG. 5. FIG. 4A is a plan view of patch antenna 10A, FIG. 4B is a right side view of patch antenna 10A, and FIG. 4C is a bottom view of patch antenna 10A. FIG. 5 is a cross sectional view of along line V-V in FIG. 4A.

As shown in FIGS. 4A to 4C and FIG. 5, orthogonal coordinate system (x, y, z) is used here. As shown in FIGS. 4A to 4C and FIG. 5, the x-axis direction encompasses the right and left directions (width direction; lateral direction), the y-axis direction encompasses the front and rear directions (depth direction; vertical direction), the z-axis direction encompasses the upward and downward directions (height direction; thickness direction).

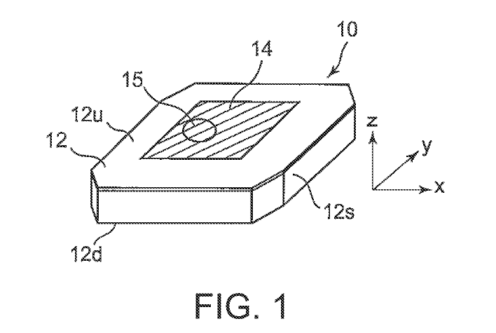

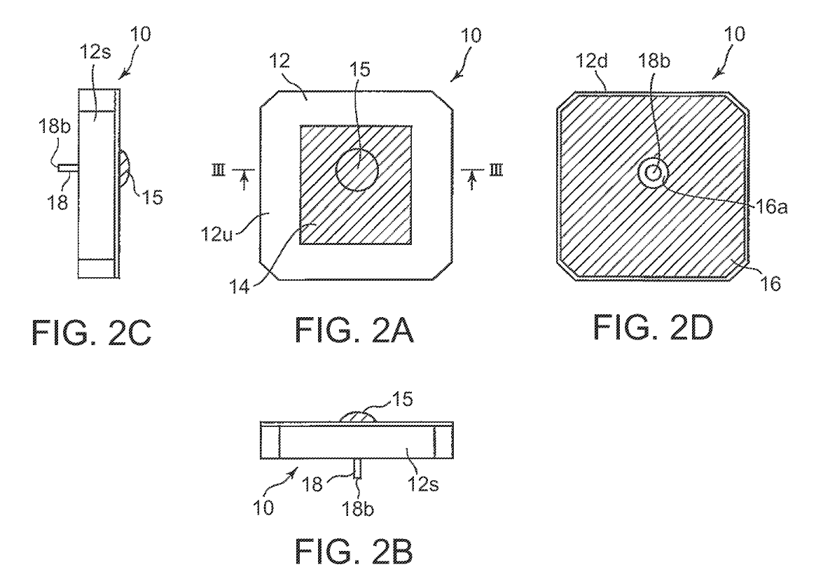

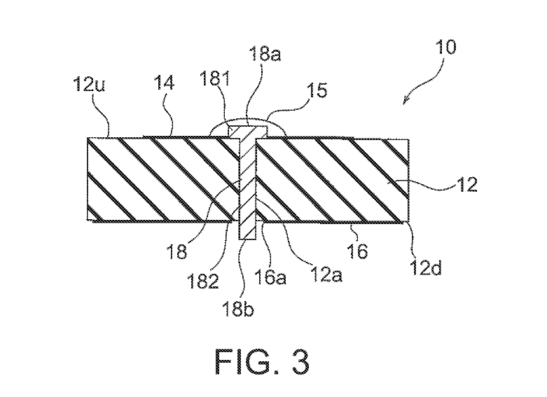

With patch antenna 10A illustrated, the configurations of the dielectric base plate, antenna radiation electrode and solder have the same configuration as conventional patch antenna 10 except for the differences from the illustrations of FIG. 1 to FIG. 3. Consequently, the dielectric base plate, antenna radiation electrode and feed point (solder) are assigned the same reference numerals 12A, 14A and 15A. Parts having the same functions as in FIG. 1 to FIG. 3 will be assigned the same reference numerals as in FIG. 1 to FIG. 3.

The outer shape of patch antenna 10A is the same as conventional patch antenna 10 shown in FIG. 1 to FIG. 3, except that there is no projection of feed point (solder) 15A.

Patch antenna 10A is used as an SDARS antenna for receiving an electric wave from an SDARS satellite, or as a GPS antenna for receiving an electric wave from a GPS satellite.

Patch antenna 10A has dielectric base plate 12A, antenna radiation electrode (radiation element) 14A, ground electrode (ground conductor) 16, feed pin 18, and feed point (solder) 15A.

Feed pin 18 is formed with a rivet pin. Feed pin (rivet pin) 18 has head 181 provided in one end 18a, and also has bar-shaped body 182 that extends from one end 18a to opposite end 18b.

A ceramic material of high permittivity, such as barium titanate, is used for dielectric base plate 12A. Dielectric base plate 12A has top surface (surface) 12u and bottom surface (back surface) 12d to oppose each other, and side surfaces 12s. Side surfaces 12s of dielectric base plate 12A are chamfered. In dielectric base plate 12A, in the position feed point 15 (solder) (described later) is provided, base plate through-hole 12a that penetrates from top surface 12u to bottom surface 12d, is drilled.

As shown in FIG. 5, dielectric base plate 12A has recess (cavity) 12c provided in the periphery of base plate through-hole 12a on the top surface 12u side. This recess 12c can accommodate head 181 of feed pin 18 and solder 15A (described later), and also has a depth that is greater than the height of head 181 of feed pin 18. The shape of this recess 12c is formed by means of a mold that is used upon making dielectric base plate 12A. Consequently, the cost of dielectric base plate 12A does not increase compared to conventional dielectric base plate 12.

To describe this in detail, recess 12c is defined by inner wall surfaces 12c-1. With the embodiment illustrated, recess 12c has, as inner wall surfaces 12c-1, bottom surface 12cb where head 181 of feed pin 18 is placed, and inclined surfaces (conical side surface) 12cs having a diameter which widens from bottom surface 12c toward top surface 12u of dielectric base plate 12A. That is to say, inner wall surfaces 12c-1 of recess 12c practically has the shape of a mortar.

Antenna radiation electrode (radiation element) 14A is formed of a conducive film, and is formed on top surface 12u of dielectric base plate 12, as well as on inner wall surfaces 12c-1 of recess 12c. That is to say, antenna radiation electrode (radiation element) 14A is formed with top surface radiating part 141 formed on top surface 12u of dielectric base plate 12, and inner wall surface radiating part 142 formed on inner wall surfaces 12c-1 of recess 12c. Bottom surface 12cb and inclined surfaces (conical side surface) 12cs of recess 12c are covered by inner wall surface radiating part 142 of antenna radiation electrode (radiation element) 14A.

Antenna radiation electrode (radiation element) 14A has virtually a square shape. Antenna radiation electrode (radiation element) 12A is formed by silver pattern printing, as will be described later. Here, for ease of explanation, top surface radiating part 141 of antenna radiation electrode (radiation element) 14A is formed by applying a silver paste by screen printing, and inner wall surface radiating part 142 is formed by applying a silver paste by pad printing.

Ground electrode (ground conductor) 16 is formed of a conductive film and is formed on bottom surface 12d of dielectric base plate 12A. This ground electrode (ground conductor) 16 has ground opening 16a that is virtually concentric with base plate through-hole 12a and that has a greater diameter than base plate through-hole 12a.

Feed point (solder) 15A is provided in a location displaced in the x-axis direction from the center of antenna radiation electrode 12A. Head 181 of feed pin 18 is connected to this feed point (solder) 15A, as described later. Feed pin 18 extends through base plate through-hole 12a and ground opening 16a, and then, apart from ground electrode (ground conductor) 16, extends further downward.

Solder is used for feed point 15A. In a state head 181 of feed pin 18 is accommodated inside recess (cavity) 12c, this feed point (solder) 15A is attached not to project upward beyond the main surface of antenna radiation electrode 14A (the main surface of top surface radiating part 141).

With the embodiment illustrated, as shown in FIG. 5, the diameter of bottom surface 12 of recess 12c is greater than the diameter of head 181 of feed pin 18. Solder 15A is attached only on bottom surface 12cb of recess 12c. Then, solder 15A is not applied to topmost surface 181a of head 181 of feed pin 18. That is to say, solder 15A connects between antenna radiation electrode (receiving electrode) 14A and head 181 of feed pin 18 in a filet shape.

The patch antenna 10A according to the first embodiment configured this way provides the following advantages.

First, it is possible to provide patch antenna 10A of a thin shape (low-profile). The reason is that, given that recess (cavity) 12c that can accommodate head 181 of feed pin (rivet pin) 18 and solder 15A is formed in dielectric base plate 12A, it is possible to prevent feed point (solder) 15A from rising upward beyond the main surface of antenna radiation electrode 14A.

Secondly, it is possible to improve the antenna gain of patch antenna 10A. The reason is that the height (thickness) of dielectric base plate 12A can be made high (thick) up to the projecting part (projection where solder 15 rises) of feed pin 18 of conventional patch antenna 10 (FIG. 1 to FIG. 3), so that it is possible to increase the volume of dielectric base plate 12A.

Thirdly, it is possible to provide patch antenna 10A that can be accommodated in a thin case and that can improve antenna characteristics. The reason is that, as described above, patch antenna 10A (dielectric base plate 12A) can be made thin (low profile) and the volume of dielectric base plate 12A can be increased.

Fourth, it is possible to make the cost of patch antenna 10A. The reason is that, solder 15A is not applied to topmost surface 181a of head 181 of feed pin 18, so that it is possible to reduce the amount of solder 15A.

Fifth, it is possible to secure the strength of connection between antenna radiation electrode 14A and head 181 of feed pin 18. The reason is that, antenna radiation electrode 14A and head 181 of feed pin 18 are connected by means of solder 15A of a filet shape.

With the first embodiment illustrated, solder 15A has a ring shape (donut shape) that is virtually concentric with base plate through-hole 12a. However, the solder may be comprised of N solder parts (N being an integer of 2 or greater) that are mutually spaced apart and that are provided in circular symmetry with respect to the center line of base plate through-hole 12a.

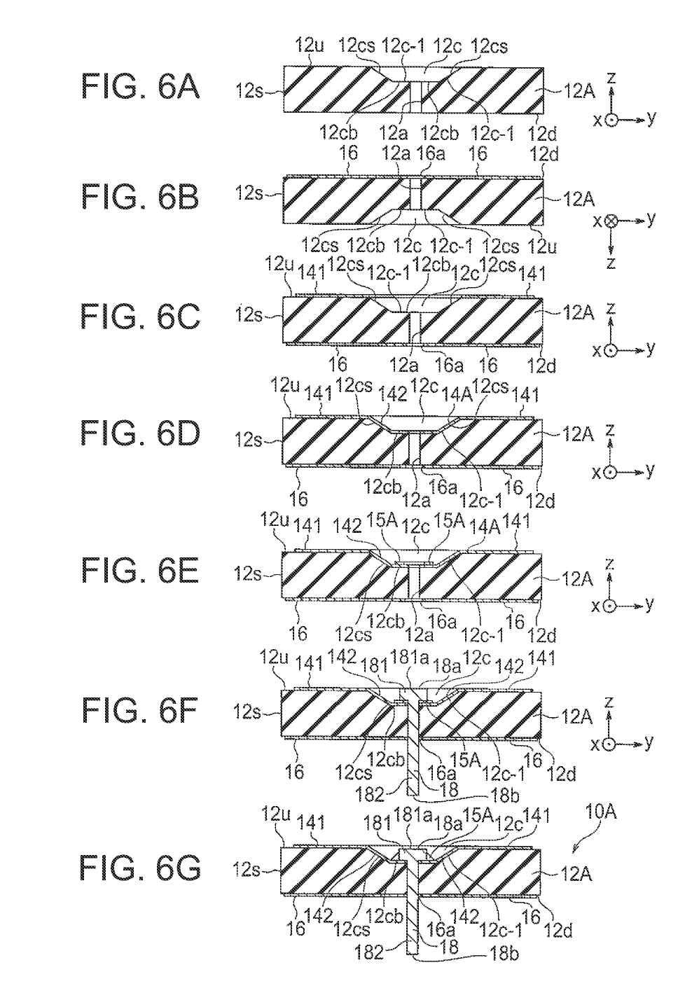

Next, with reference to FIG. 6 now, the method of making patch antenna 10A shown in FIGS. 4A TO 4C and FIG. 5 will be described. FIG. 6A to FIG. 6G show the steps of making patch antenna 10A.

First, as shown in FIG. 6A, dielectric base plate 12A is prepared that has mutually opposing top surface 12u and bottom surface 12d. That is to say, a powder that contains barium titanate or the like as a main material and that is mixed with a supplement (i.e. binder) is shaped in a mold, and the molding result is baked to provide dielectric base plate 12A. This resulting dielectric base plate 12A has base plate through-hole 12a, which, in a predetermined location, bar-shaped body 182 of feed pin 18 can penetrate from top surface 12u to bottom surface 12d, and recess (cavity) 12c which is provided on the periphery of base plate through-hole 12a on the top surface 12u side. This recess 12c can accommodate head 181 of feed pin 18, and also has a depth that is greater than the height of head 181 of feed pin 18. Recess 12c is defined by inner wall surface 12c-1.

To be more specific, the step of preparing dielectric base plate 12A includes a step of forming recess 12c having, as inner wall surfaces 12c-1, bottom surface 12cb on which head 181 of feed pin 18 is placed, and inclined surfaces (conical side surfaces) 12cs having a diameter which widens from bottom surface 12c toward top surface 12u of dielectric base plate 12A.

Either way, by using a mold, it is possible to form (prepare) dielectric base plate 12A having base plate through-hole 12a and recess (cavity) 12c.

Next, as shown in FIG. 6B, ground electrode 16 formed of a conductor is formed on bottom surface 12d of dielectric base plate 12A. This ground electrode 16 has ground opening 16a that is virtually concentric with base plate through-hole 12a, and that has a greater diameter than the diameter of base plate through-hole 12a. This ground electrode 16 is formed by applying a silver paste on bottom surface 12d of dielectric base plate 12A by screen printing.

To be more specific, first, a ground electrode forming mask is formed (mounted) on bottom surface 12d of dielectric base plate 12A. This ground electrode forming mask has a mesh shape, and the mesh is coarse in the part (area) where a silver paste is to be applied and the mesh is fine in the part (area) where a silver paste is not to be applied. With the ground electrode forming mask of this example, the mesh in the part (area) corresponding to ground opening 16a is fine.

Next, a silver paste is placed on a ground electrode forming mask. Then, a squeegee is moved in a predetermined direction to press silver paste 1 against bottom surface 12d of dielectric base plate 12A. By this means, as shown in FIG. 6B, a silver paste is applied on bottom surface 12d of dielectric base plate 12A.

Afterward, the ground electrode forming mask is removed from bottom surface 12d of dielectric base plate 12A. By this means, silver paste 16 of a predetermined pattern is screen-printed on bottom surface 12d of dielectric base plate 12A. Afterward, by drying this silver paste 16, ground electrode 16 of a predetermined pattern is formed (printed) on bottom surface 12d of dielectric base plate 12A.

Next, as shown in FIG. 6C, top surface radiating part 141 of antenna radiation electrode 14A formed of a conductor is formed on top surface 12u of dielectric base plate 12A. Similar to ground electrode 16 described above, top surface radiating part 141 of antenna radiation electrode 14A is formed by applying a silver paste on top surface 12u of dielectric base plate 12A by screen printing.

To be more specific, first, a radiation electrode forming mask is formed (mounted) on top surface 12u of dielectric base plate 12A. Similar to the above ground electrode forming mask, this radiation electrode forming mask has a mesh shape, and the mesh is coarse in the part (area) where a silver paste is to be applied and the mesh is fine in the part (area) where a silver paste is not to be applied. With the radiation electrode forming mask of this example, the mesh in the part (area) corresponding to recess 12c is fine.

Next, a silver paste is placed on the radiation electrode forming mask. Then, a squeegee is moved in a predetermined direction to press the silver paste against top surface 12u of dielectric base plate 12A. By this means, as shown in FIG. 6C, silver paste 141 is applied on top surface 12u of dielectric base plate 12A.

Afterward, the ground electrode forming mask is removed from bottom surface 12d of dielectric base plate 12A. By this means, silver paste 141 of a predetermined pattern is screen-printed on top surface 12u of dielectric base plate 12A. Afterward, by drying this silver paste 141, ground electrode 16 of a predetermined pattern is formed (printed) on top surface 12u of dielectric base plate 12A.

Next, as shown in FIG. 6D, on inner wall surfaces 12c-1 defining recess 12c of dielectric base plate 12A, inner wall surface radiating part 142 of antenna radiation electrode 14A formed of a conductor is formed. Inner wall surface radiating part 142 of this antenna radiation electrode 14A is formed by applying a silver paste on inner wall surfaces 14c-1 of recess 14c by pad printing.

To be more specific, “pad printing” refers to a printing method of transcribing ink on a soft, semi-spherical or bilge-shaped pad of silicon rubber once, and then pressing the pad against a print-target object and transcribing the ink on a pad. Pad printing is also referred to as “tampo printing.”

First, a recessed plate is prepared. A recess (etching) having the shape of antenna pattern (inner wall surface radiating part) 142 to be transcribed is formed on the top surface of this recessed plate.

Subsequently, a conductive paste is placed on (over) this recessed plate. The conductive paste is formed of a silver paste. Afterward, excess conductive paste is wiped off (removed) off using a blade. By this means, a conductive paste leaves in the recess (etching) on the recessed plate. Then, this recessed plate is moved to below the pad. The material of the pad is silicon rubber.

Following this, the pad is placed against the recessed plate. By this means, it is possible to place the conductive paste left in the recess (etching) on the recessed plate and the pad in close contact with each other.

Subsequently, the pad is placed is removed from the recessed plate, and the conductive paste that is left in the recess (etching) of the recessed plate is transcribed. Then, the recessed plate is moved apart from the pad. Below the pad, dielectric base plate 12A, which is the print-target object, is placed.

Consequently, looking up at the pad from print-target object (dielectric base plate) 12A, this conductive paste, transcribed on the pad, has the shape of the transcribing surface (inner wall surface radiating part) 142.

With this example, print-target object (dielectric base plate) 12A has a shape in which recess 12c is formed in top surface 12u.

Following this, the pad is pressed against top surface 12u of print-target object (dielectric base plate) 12A.

Finally, the pad is removed from top surface 12u of print-target object (dielectric base plate) 12A, and the conductive paste is transcribed on print-target object (dielectric base plate) 12A. By this means, pad printing is finished.

By pressing the pad against top surface 12u of print-target object (dielectric base plate) 12A, inner wall surface radiating part 142 of antenna radiation electrode 14A is printed on inner wall surfaces 12c-1 of recess 12c of print-target object (dielectric base plate) 12A.

Either way, by using screen printing and pad printing together, it is possible to form antenna radiation electrode 14A on top surface 12u of dielectric base plate 12A and on inner wall surfaces 12c-1 of recess 12c.

Consequently, with the embodiment illustrated, top surface radiating part 141 is formed first by screen printing and then inner wall surface radiating part 142 is formed by pad printing, but the order of these can be reversed. That is to say, it is possible to first form inner wall surface radiating part 142 by pad printing as shown in FIG. 6D, and then form top surface radiating part 141 by screen printing as shown in FIG. 6C.

Next, as shown in FIG. 6E, solder paste 15A is placed on antenna radiation electrode 14A (inner wall surface radiating part 142) formed on inner wall surface 12c-1 of recess 12c, in a location where head 181 of feed pin 18 is placed.

In the example illustrated, the step of placing solder paste 15A is a step of applying solder paste 15A on antenna radiation electrode 14A (inner wall surface radiating part 142), which is formed on bottom surface 12cb of recess 12c, in a donut shape that is virtually concentric with base plate through-hole 12a. This step of applying solder paste 15A can be performed using, for example, a general dispenser (syringe).

Although with the illustrated embodiment solder paste 15a is applied in a donut shape, instead, the above step of placing solder paste 15A may be a step of placing solder 15A of a paste ring on antenna radiation electrode 14A formed on bottom surface 12cb of recess 12c.

Following this, as shown in FIG. 6F, body 182 of feed pin 18 is pressed in base plate through-hole 12a from top surface 12c of dielectric base plate 12A. By this means, head 181 of feed pin 18 is placed on solder paste 15A.

Finally, in an electric furnace, solder paste 15A is melted by reflow. By this means, as shown in FIG. 6G, head 181 of feed pin 18 is covered by solder 15A, antenna radiation electrode 14A (inner wall surface radiating part 142) and feed pin 18 are conductively connected. Solder 15A connects between antenna radiation electrode (receiving electrode) 14A and head 181 of feed pin 18 in a filet shape.

Patch antenna 10A is made this way.

According to the first embodiment illustrated, the step of placing solder paste 15A (FIG. 6E) is a steps of placing solder 15A of a ring shape (donut shape) that is virtually concentric with base plate through-hole 12a, on antenna radiation electrode 14C formed on bottom surface 12cb of recess 12c.

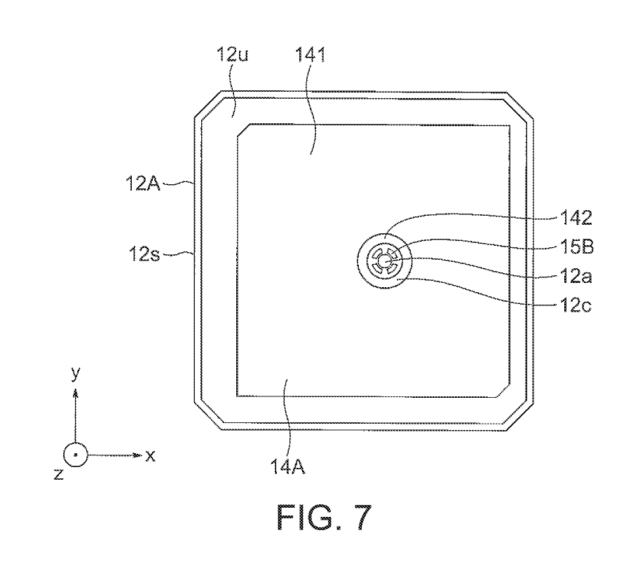

For example, instead of FIG. 6E, as with the second embodiment shown in FIG. 7, the step of placing the above solder paste may be a step of applying four solder pastes 15B that are provided mutually spaced apart and that are provided in a circular symmetry with respect to the center line of base plate through-hole 12a, on antenna radiation electrode 14A (inner wall surface radiating part 142) formed on bottom surface 12cb of recess 12c.

The step of applying four solder pastes 15B may be carried out using, for example, a general dispenser (syringe) such as described above. However, to apply these four solder pastes 15B more easily, for example, it is equally possible to apply four solder pastes 15B using a dispenser (syringe) of a special shape having a four injection holes in its tip.

After this, as shown in FIG. 6F and FIG. 6G, a step of pushing feed pin 18 in base plate through-hole 12a from top surface 12u of dielectric base plate 12A and placing head 181 of feed pin 18 on four solder pastes 15B, and a step of melting four solder pastes 15B by reflow and soldering feed pin 18, are carried out.

By this means, head 181 of feed pin 18 is covered by solder 15B in four places, and antenna radiation electrode (receiving electrode) 14A and head 181 of feed pin 18 are jointed in a filet shape.

With the patch antenna according to the second embodiment made this way, solder is formed with four solder parts 15B that are provided mutually spaced apart and that are provided in a circular symmetry with respect to the center line of feed pin 18 (base plate through-hole 12a).

Patch antenna according to a second embodiment configured this way has the following advantages.

First, it is possible to provide a patch antenna of a thin shape (low-profile). The reason is that, given that recess (cavity) 12c that can accommodate head 181 of feed pin (rivet pin) 18 and solder 15B is formed in dielectric base plate 12, it is possible to prevent feed point (solder) 15B from rising upward beyond the main surface of antenna radiation electrode 14A.

Secondly, it is possible to improve the antenna gain of a patch antenna. The reason is that the height (thickness) of dielectric base plate 12A can be made high (thick) up to the projecting part (projection where solder 15 rises) of feed pin 18 of conventional patch antenna 10 (FIG. 1 to FIG. 3), so that it is possible to increase the volume of dielectric base plate 12A.

Thirdly, it is possible to provide a patch antenna that can be accommodated in a thin case and that can improve antenna characteristics. The reason is that, as described above, a patch antenna (dielectric base plate 12A) can be made thin (low profile) and the volume of dielectric base plate 12A can be increased.

Fourth, it is possible to make the cost of a patch antenna. The reason is that, solder 15A is not applied to topmost surface 181a of head 181 of feed pin 18, so that it is possible to reduce the amount of solder 15B. That is, solder 15B is applied only in four places at equal angular intervals, instead of the entire periphery of head of feed pin 18, so that it is possible to reduce the amount of solder 15B.

Fifth, it is possible to secure the strength of connection between antenna radiation electrode 14A and head 181 of feed pin 18. The reason is that, antenna radiation electrode 14A and head 181 of feed pin 18 are connected by means of solder 15B of a filet shape. In other words, stress is spread so that it is possible to prevent feed pin 18 from falling.

With the second embodiment shown in FIG. 7, head 181 of feed pin 18 is connected with antenna radiation electrode 14A by means of solder 15B in four places at circular symmetrical locations (spaced at equal angular intervals), but this is by no means limiting. That is to say, generally speaking, it is possible to connect head 181 of feed pin 18 to antenna radiation electrode (radiation element) 14A by means of solder 15B in N places (N being an integer of two or more) at circular symmetrical locations (spaced at equal angular intervals).

Now, although preferred embodiments of the present invention have been described above, the present invention is by no means limited to these embodiments. Although with the above embodiments silver paste is used as a conductive paste, it is equally possible to use different conductive pastes. Although with the above embodiments an antenna radiation electrode has a square shape, this antenna radiation electrode may equally have a circular shape. Also, the material of the dielectric base plate is by no means limited to a ceramic material and it is equally possible to use a resin material. Furthermore, the patch antenna of the present invention is suitable for a GPS antenna or SDARD antenna but nevertheless is by no means limited to these, and may equally be used as a mobile communications antenna to receive other satellite waves and terrestrial waves.

What is claimed is:

1. A patch antenna comprising:
a dielectric base plate having a top surface and a bottom surface facing each other, and having a base plate through-hole penetrating from the top surface to the bottom surface at a predetermined location;
an antenna radiation electrode formed on the top surface of the dielectric base plate;
a ground electrode formed on the bottom surface of the dielectric base plate and having a ground opening, said ground opening being substantially concentric with the base plate through-hole and having a diameter greater than that of the base plate through-hole; and
a feed pin having a head provided on an upper end thereof and a bar-shaped body extending from the upper end to a lower end thereof, said head being connected to the antenna radiation electrode with solder at the predetermined location, said lower end being derived toward the bottom surface of the dielectric base plate via the base plate through-hole and the ground opening,
wherein the dielectric base plate has a recess provided in a periphery of the base plate through-hole on a side of the top surface for accommodating the head and the solder, said recess having a depth greater than a height of the head;
the antenna radiation electrode is formed on an inner wall surface of the recess; and
the solder is placed below a main surface of the antenna radiation electrode in a state that the head is accommodated in the recess.

2. The patch antenna according to claim 1, wherein the recess has the inner wall surface including a bottom surface with the head placed thereon and an inclined surface having a diameter increasing from the bottom surface toward the top surface of the dielectric base plate, said inner wall surface substantially having a shape of a mortar.

3. The patch antenna according to claim 2, wherein the recess includes he bottom surface having a diameter greater than that of the head, and the solder is placed only on the bottom surface.

4. The patch antenna according to claim 3, wherein the solder is placed on an area except a topmost surface of the head.

5. The patch antenna according to claim 4, wherein the solder includes solder parts in a number of N, N being an integer of two or more, said solder parts being arranged apart from each other with a space in between in a rotational symmetry pattern with respect to a center line of the base plate through-hole.

6. The patch antenna according to claim 1, wherein the dielectric base plate substantially has a cuboid shape.

7. The patch antenna according to claim 1, wherein the dielectric base plate is formed of a ceramic material.

8. The patch antenna according to claim 1, wherein the antenna radiation electrode is formed of a silver paste coated through screen printing on the top surface of the dielectric base plate, and is formed of a silver paste formed through pad printing on the inner wall surface of the recess.

9. The patch antenna according to claim 1, wherein the antenna radiation electrode substantially has a square shape.

10. The patch antenna according to claim 1, wherein the patch antenna is a global positioning system antenna to receives an electric wave from a global positioning system satellite.

11. The patch antenna according to claim 1, wherein the patch antenna is a satellite digital audio radio service antenna to receive an electric wave from a satellite digital audio radio service satellite.

12. A method of producing a patch antenna through soldering a feed pin to a dielectric base plate, said feed pin having a head that provided on an upper end thereof and a bar-shaped body extending from the upper end to a lower end thereof, the method comprising the steps of:
preparing the dielectric base plate having a top surface and a bottom surface facing each other, and having a base plate through-hole penetrating from the top surface to the bottom surface at a predetermined location, said dielectric base plate further including a recess in a periphery of the base plate through-hole on a side of the top surface for accommodating a head of the feed pin, said recess having a depth greater than a height of the head;
forming a ground electrode on the bottom surface of the dielectric base plate, said ground electrode having a ground opening substantially concentric with the base plate through-hole and having a diameter greater than that of the base plate through-hole;
forming an antenna radiation electrode on the top surface of the dielectric base plate and an inner wall surface of the recess;
placing a solder paste on the antenna radiation electrode at a location where the head is placed;
pushing the body in the base plate through-hole from the top surface of the dielectric base plate so that the lower end is derived toward the bottom surface of the dielectric base plate and the head is placed on the solder paste; and
melting the solder paste through reflow to solder the feed pin.

13. The method according to claim 12, wherein the step of forming the antenna radiation electrode includes applying a silver paste on the top surface of the dielectric base plate through screen printing, and applying the silver paste on the inner wall surface of the recess through pad printing.

14. The method according to claim 13, wherein the step of preparing the dielectric base plate includes forming the recess to have the inner wall surface including a bottom surface with the head placed thereon and an inclined surface having a diameter increasing from the bottom surface toward the top surface of the dielectric base plate.

15. The method according to claim 14, wherein the step of placing the solder paste includes applying the solder paste in a donut shape on the antenna radiation electrode.

16. The method according to claim 14, wherein the step of placing the solder paste includes placing the solder paste in a ring shape on the antenna radiation electrode.

17. The method according to claim 14, wherein the step of placing the solder paste includes applying solder parts in a number of N, N being an integer of two or more, on the antenna radiation electrode, said solder parts being arranged apart from each other with a space in between in a rotational symmetry pattern with respect to a center line of the base plate through-hole.
